(19) United States
(12) Patent Application Publication
(10) Pub. No.: US 2010/0306828 A1
(43) Pub. Date: Dec. 2, 2010

(54) Method for Secure Validation Utilizing Existing Validation Framework

(76) Inventors: Curt Grob, Mountain Pleasant, SC (US); Pat Guariglia, Catskill, NY (US)

Correspondence Address: Curt Grob, 417 mount Royall Drive, Mount Pleasant, SC, 29464, US

(21) Appl. No.: 12/495,856

(22) Filed: Jul. 1, 2009

Related U.S. Application Data
(60) Provisional application No. 61/182,725, filed on May 31, 2009.

(51) Int. Cl. G06F 21/00

(52) U.S. Cl. 726/4

(57) ABSTRACT

Granting secure access to stored digital medical information to patients or healthcare providers facilitates information exchange in healthcare. Payment for healthcare services can be accomplished with a credit card or other electronic payment means. Each payment transaction is assigned a unique ID number by financial services computer systems, itself being transmitted with temporal information to the medical record system at the time of issuance. Receiving medical record system(s) incorporate the ID number into the validation process by requiring it during validation in defined time frame from issuance. When correctly entered in the time frame allocated, patient medical information is displayed on the requestor's computer screen. If the ID is not entered in the determined time frame, access if not granted. Transaction ID number usage therefore provides a temporal limit on access to the patient's medical information and serves as an additional validation mechanism.

### CROSS REFERENCE TO RELATED APPLICATION

This application is a continuation-in-part of U.S. provisional patent No. 61182725 filed May 31, 2009.

### REFERENCES CITED

U.S. Patent Documents

| | | | |
|---|---|---|---|
| 5,579,393 | November 1996 | Conner et al. | 380/25 |
| 6,694,387 | February 2004 | Wagner | 710/33 |
| 4,755,940 | July 1988 | Brachtl et al. | 364/408 |
| 4,471,216 | September 1984 | Herve | 235/380 |
| 6,282,656 | September 2001 | Wang | 713/201 |
| 6,871,193 | March 2005 | Campbell et al. | 705/67 |
| 6,226,752 | 713/201 | Gupta et al. | May 2001 |
| 7,296,160 | November 2007 | Hiltgen | November 2007 |
| 6,661,904 | December 2003 | Sasich et al. | December 2003 |
| 7,174,383 | February 2007 | Biswas et al. | February 2007 |

This invention was not developed with federally sponsored research or development.

### BRIEF DESCRIPTION OF DRAWINGS

FIG. 1 is a diagram of information storage and utilization of health care information in present invention.

FIG. 2 is a diagram of credit card usage and flow of information.

FIG. 3 is a flowchart of credit card transaction data.

FIG. 4 is a flowchart of data interchange between healthcare server and financial server of the present invention.

FIG. 5 is a diagram of web page showing first step in validation in present invention.

FIG. 6 is a diagram of web page showing second step in validation in present invention.

FIG. 7 is a diagram of web page showing alternative second step in validation in present invention, specifically utilization of drop down menu for validation.

FIG. 8 is a diagram of web page showing authorization number field for validation in present invention.

### BACKGROUND

The practice of medicine is dependent upon accurate information being available to healthcare providers treating patients, to facilitate a diagnosis and treatment of the patient's medical problems. Medical information is maintained in paper records and digitally on computers. A patient's medical information, while essential to medical care, contains intimate information about the patient that should be privy to the healthcare providers and only those with a need to view it. As such, protecting access to this information is important. Various methods have been employed in the past to limit access to healthcare information, such as passwords, securely encoding the information on media viewable only with decryption software and appropriate keys, limiting information to standalone computer systems, and the like. With the internet, patient information is geographically more accessible via a web browser and internet connection. However, validation of those accessing the information is more difficult, for example, passwords can be hacked. It is desirable to have multiple layers of security to further prevent unauthorized access to medical information via the web.

Electronic financial transactions also require validation to ensure that the person requesting payment is authorized to do so. For credit cards and debit cards provided by payers the user signs the receipt and/or enters a personal identification code/number (PIN) at the time of the transaction to validate their identity. If the PIN does not match the number on file, the transaction cannot proceed. Similarly, if the signature does not match that of the owner, often displayed on the back of the card, the transaction is not facilitated. If the transaction is approved, the financial payer computer system assigns a transaction number for that payment. This number is unique to the transaction and is uniquely assigned each time the credit card or payment system is used. The transaction number facilitates the tracking of the charges made by the payer.

Utilizing the financial transaction data for further validation of those accessing a patient's medical information provides an additional measure of security.

### SUMMARY OF THE INVENTION

The present invention relates to validation of a users identity with secure software or web based systems. The invention provides a means of secure validation of a person's permission to access their health record utilizing credit card validation measures as an additional temporal limitation and security measure.

A standard web page viewed in any web browser is presented to the user requesting their unique identifier for accessing their health information. This unique identifier is comprised of a number unique to the patient, a credit card number, unique username, or the like. Patient then enters the identifier and proceeds to the next screen, or is given the error message “sorry your identification information is not found” with links to try again or register for usage of the service. The user is given three tries until the system prevents further login under that username, credit card number, unique username, or the like. With validation of this identifier the user is then directed to a secure question of which the patient/account holder has entered prior with registration for the service. The answer to this question may be dynamically presented with similar dynamically generated responses in a pull-down menu to be selected or alternatively the response may be typed into a field on the page. If the user does not successfully enter the correct response, the user is offered three more opportunities to enter the correct answer to the security question. If this is not accomplished the system prevents the user from opening the account and sends an email on record for the user documenting this failure to validate. The system may present one or several levels of security questions to the user. Upon successful answers to the security questions, the user is directed to a page requesting the user enter a transaction number for the entering the related health record. This transaction number, also known as an authorization number, is generated for each transaction that occurs when an individual utilizes their credit card. The user swipes the account holder's card in a credit card reader at the site of healthcare. A monetary value designated by the healthcare provider, such as a fee for the visit, or a zero monetary value may be entered into the credit card reader. This financial transaction will generate a transaction number at that time and a time the transaction number was issued. Commonly the number is printed on the credit card receipt printed by the credit card reader or displayed on the credit card reader at the site of care. This transaction number is electronically transmitted from the financial computer system to the medical records computer system/server with a time and date of issuance by the financial computer system. The transaction number must be entered in the field on the transaction number page within a set period of time specified by the medical record server arbitrarily valued herein as 10 minutes. This sets a temporal limit to which the medical record can be accessed by the user on a website. After this temporal limit, the user must begin the login process from the start. Alternatively, the financial computer system may issue a number independent of the transaction number that can be employed on the healthcare website to login. When the transaction number is transmitted with date and time to the medical record server, it is entered into the database for that user whom has medical information on that medical record server. When the user types the transaction number on the webpage requesting it, within the temporal limit specified, the system approves the user and displays the medical information on the screen. Of note, the initial page requesting the transaction number or generated number may employ a timeout assigned to it whereby the transaction number is unable to be entered after the timeout expires and the user must begin at the first page. This affords extra security to the account. The purpose of this invention is to employ a financial services card, such as a credit card, or the like, and transaction number, normally a part of a purchase or financial transaction, to afford extra security to an identity validation login to healthcare information available online.

### DETAILED DESCRIPTION OF INVENTION

In the preferred embodiment “user” is the patient themselves, viewing and interacting with the system to enter medical information or access their medical record for their own viewing or for viewing by themselves or with others present of the patients choosing. Alternatively the term “user” may apply in the preferred embodiment to a healthcare professional to whom the patient requires view their medical information for treatment or otherwise.

Validation of a user attempting to access an online database is commonly accomplished via a username and password. The individual “patient” user creates or has assigned to them a username unique to them, commonly utilizing alphanumeric characters of a minimum character length. A password is also selected or created for the user, commonly of alphanumeric characters of varying length. Both of these are stored in fields in a database for the respective user linked by their username or a common key number. When future attempts are made to access the information stored in the database, a web application utilizes the username and password entered into the webpage to validate the user. When both are entered and match the data in the database for the user, the server then provides the requested information stored for the user. If no match is found, the server does not display the information in the web browser or web enabled application.

Medicine is a service providing patients with medical advice, treatment of conditions and the like occurring between healthcare providers and a corresponding patient. This action is dependent on information provided by the patient, information from lab tests, imaging studies, stored in files from past medical encounters, etc. Accessing this information is done by healthcare providers at the site of care. Information may be entered into stored files by healthcare providers as notes, imaging studies, etc. Healthcare data in digital format, such as electronic medical records, is stored in digital format on servers at the site of its creation or may be stored at a disparate site of creation.

With internet or network connections the medical data can be accessed on the servers remotely by healthcare providers or patients on a computer, portable device, or the like. Accessing the information via a server from a remote location to its storage necessitates the inclusion of security provisions to prevent the unauthorized access of the patient's medical information. Patient information is considered private and should be viewed only those with need to view the information, such as the patients healthcare providers. As such, security provisions are an essential aspect of the delivery of digital healthcare information.

Payment for the healthcare interaction, for services delivered by the healthcare provider to the patient is most often facilitated by health insurance. Credit cards are commonly used as payment for the transactions required by the patient, such as co-pays, etc. Clearly, integration of payment and medical record information will provide benefit to healthcare providers and patients tracking their healthcare information, expenditures and the like. Most medical providers utilize credit cards for payment of services rendered.

Personal health records are software applications that allow patients to maintain a collection or complete record of their health history. A patient may keep their allergies, medications, surgeries, medical problems, healthcare providers, hospitals visited, etc. on the application as a means to keep a complete health history of all conditions, treatments and providers visited in a patient's life. These applications may be an application run locally on a computer or may be web based, with applications residing on a server accessed by patients and healthcare providers via a web browser. The preferred embodiment utilizes a web based application.

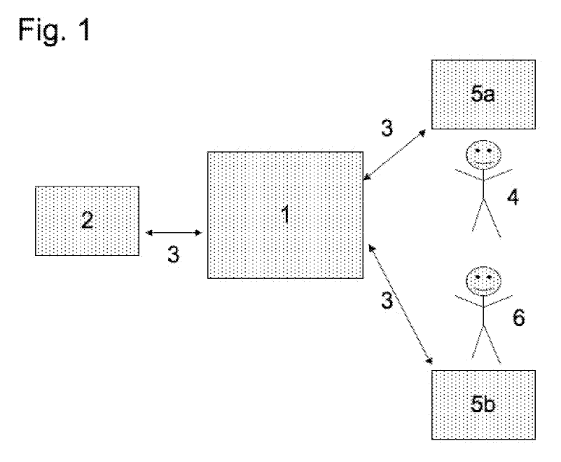

In a preferred embodiment of the invention a system, as depicted in FIG. 1, comprised of a server 1, a remote computer 2, an internet connection 3, a patient 4, the patients computer 5a, healthcare provider 6 and healthcare providers computer 5b. The patient uses their computer 5a connected to the internet 3 to enter medical information via a webpage consisting of personal health record application to store information on the server 1. Healthcare providers 6 on their computer 5b utilize an internet connection to access information stored on server 1 relating to patient 4. Patient 4 may enter information relevant to their health utilizing an internet connection and web application to store it on server 1. Other computers, such as those processing laboratory values, imaging results or the like may be represented by the computer 2 in FIG. 1. The computer 2, utilizes an internet connection, preferably secure, to transmit data for storage on server 1. This information in addition to the information entered by the patient is viewable by the patient via a secure internet connection and web application on computer 5a. This information is also viewable by a healthcare provider via a secure internet connection and web application on computer 5b. To access information on computer 5aor 5b, the user must be validated and to view the information stored in server 1. This validation is accomplished commonly by a password known to those with permission to view the information.

As shown in FIG. 1, medical information is stored on server 1 in a database with tables relative to the patient and their health history. These tables each have an identifier known as a key that links them to a computer database program. And can relate information in each table to the other respectively in the database.

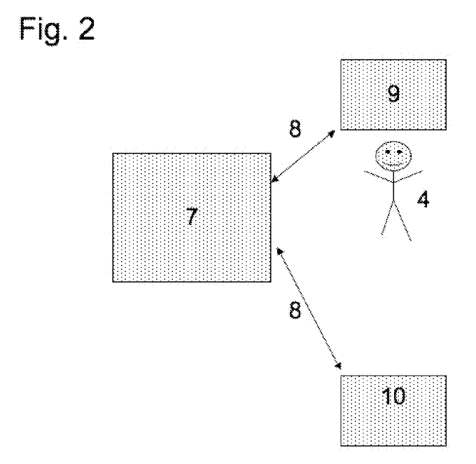

Credit card transactions enable a person to use a credit card to purchase an item at a merchant. This transaction is figurative depicted in FIG. 2. The customer enters a business, purchases items and presents a card for purchase of the goods. The card contains a number that is unique to the card holder. The card also has an expiration date on it and more commonly, an additional code of 3 or more digits that are an additional security measure. Upon swiping the card at the in-store terminal 9, information encoded on the magnetic strip on the card signifying the card number, expiration date and additional verification code is converted to a digital signal and transmitted to the credit card companies servers 7 by a phone line or internet connection 8. The server then processes the request by comparing the information in the database for the card holder. Specifically the values for the card number, the key in the database, are compared to the expiration date and additional validation numbers, if these are valid then the value of the purchase is compared to the amount of credit available in the database for that user or cardholders If the amount of the purchase is greater than the numerical value of the credit available in the database, the transaction is declined. If the purchase value is less than the amount of credit available as determined by the database and server, it is allowed to proceed and a receipt with validation code is printed at the credit card terminal 9. The user can use their computer at home 10 connected via the internet 8 to check specifics of their credit account located on the credit servers 7.

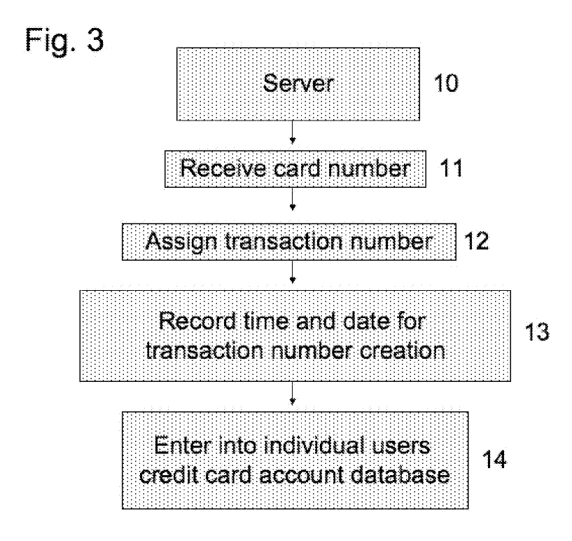

As depicted graphically in FIG. 3, each time the credit card server 10 receives a request for a transaction by the card number of the individual 11 a transaction number unique to that transaction 12 is assigned to that request for a transaction along with the time and date of the creation of the transaction number. These values are entered into a database for the card number of the cardholder 14. Later information such as the amount request for the charge, charge approved, etc. is also recorded in the database for future reference. This workflow and the state of the art will be appreciated by those familiar with the art.

One preferred embodiment relates to a system for utilizing credit card transaction data for validation of a user when accessing medical or health care records associated to the credit card holder. System in this disclosure relates to computer software, programming, script or the like performing functions as specified below.

The present invention relates to combining the validation process of credit cards to other web applications, specifically to accessing healthcare related information.

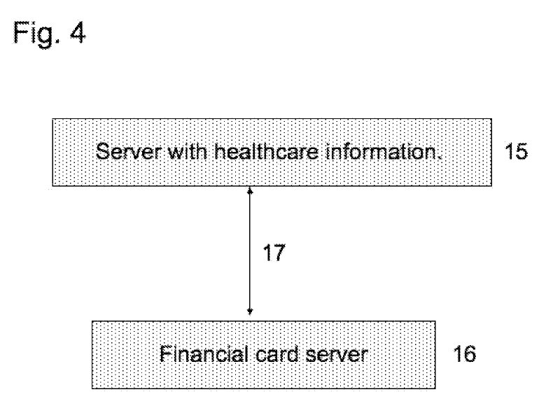

A preferred embodiment of the invention as depicted in FIG. 4 utilizes a web application electronically residing on a server containing healthcare information relating to a patient 15. This healthcare information server is connected to a financial credit card server 16 via an internet connection, hard-line connection, virtual private network (VPN), or the like 17. Healthcare providers may desire information relating to patients with information stored in the personal health record web application located on the server 15. Credit card information for the users in the database is stored between the two servers using linker tables. Healthcare information can be entered into the healthcare server by the patient, by other physicians to be stored on the patient's tables, by other medical information sources such as laboratory servers, and the like. This information can be entered initially on the healthcare server and a linker table generated or the opposite, a linker table generated for financial card numbers created at first.

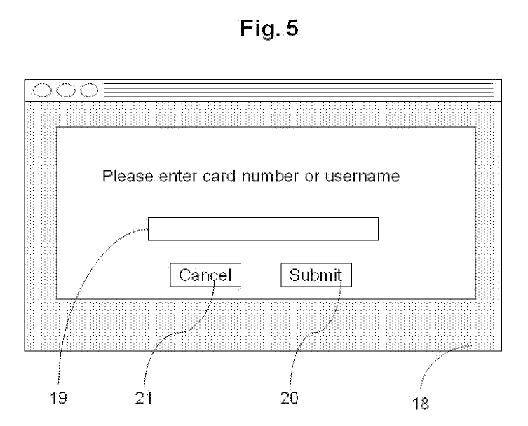

To provide access to information on the server for treatment use or the like, a page is displayed on the user's computer, accessed via the internet and a secure internet connection requesting the card number of the patient user. This is viewed in a web browser. An example of this screen is shown in FIG. 5. This screen as a component of the preferred embodiment may be a component of the personal health record application or credit card web application located on its servers facilitating cardholder access to account information.

This webpage is displayed at the point of healthcare delivery, at the physician's office, emergency room, hospital, etc. to provide viewing of the patient's medical information to healthcare providers.

In the following preferred embodiment the “system” is a web application residing on the health record, personal health record servers or on the financial services servers. As shown in FIG. 5, a screen is shown depicting a web browser screen 18 with the credit card number field 19 and submit 20 and cancel 21 buttons. When the user enters the patient's credit card number into field 19 and clicks submit 20 the system transmits the data to servers to begin the authorization process. The system queries the database and checks if the card number exists in the system's database. If the number is found the system checks for restrictions on the number in the database. If restrictions are found, such as limits placed by the credit card issuer or otherwise, e.g. card account has been closed, an alert to this effect is then displayed in the user's browser and the session is terminated.

If no restrictions are found then the system queries the database for information relating to the name, security questions and the like of the credit card holder. The information retrieved for the credit card holder's account is cached by the system until needed by the web application. Once needed, this information is then displayed in the web browser and confirmation of the user's identity is initiated. This additional confirmation step provides additional prevention of unauthorized viewing of the medical information in the healthcare database for the cardholders This precludes the possibility of improper entrance of card number, etc. into the web form.

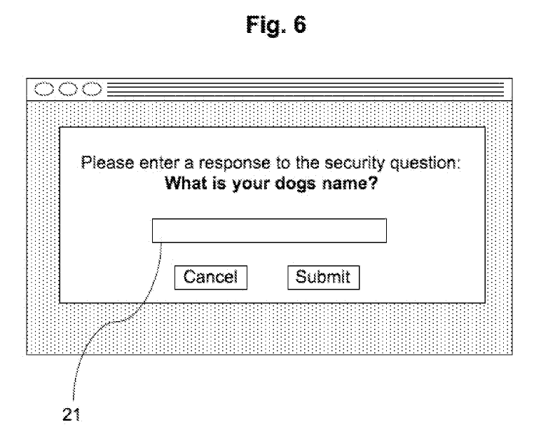

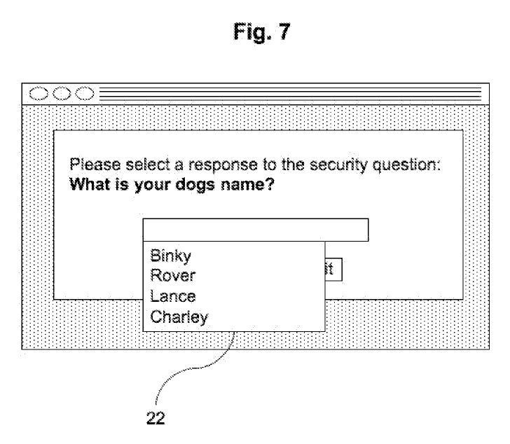

A security question is presented to the user desiring access. In the preferred embodiment this is the patient or patient's representative desiring access to their medical record at the point of care in a healthcare facility. This security question is determined by the user when they register their account. This security question may be selected from several questions from a menu or may be user generated. According to which security question is selected the system will present the user with a web screen as shown in FIG. 6 with a text field that their user can type in the correct answer to the security question 21. Alternatively as shown in FIG. 7, with some preferred embodiments the system may select several random answers generated in advance from a multitude of prior decoy questions presented in a drop down menu with the correct answer 22. Upon typing the correct answer to the security question or selection of a correct answer from a drop down menu, the system compares the answer to its database field corresponding to the answer submitted on registration. If there is a correct match the user is directed to a second security question generated and answered in a method identical to the above method for generation and answering of a security question. Those familiar with the art will respect other similar means to accomplish the above.

If the user types an incorrect answer into the text field, the window refreshes and a warning is presented to the user that an incorrect answer was entered. The user is allowed to enter an answer two more times. If a correct answer cannot be entered a notification is sent to the card holder registrant's email notifying them of the attempt to log into their account, and the time and date of the unsuccessful login is noted in the system database under the user's information.

As in FIG. 7, a drop down menu may be employed to facilitate a secure login to the application. This means is an alternative to utilizing a text box whereby the user enters information by typing it into the text box. In selecting a drop down menu 22, the user can select an answer that only they may know the answer to from the selections on the dropdown menu. If the user types an incorrect password, they are not allowed to login and the field is reset to allow another try. If the user selects the incorrect answer from the drop down menu, the known correct answer is presented to the user on a refreshed dropdown menu. This correct answer is presented on a list comprised of randomly generated answers. This method is an alternative to resetting the text field for a second, third, etc. attempt to login to the medical record.

The order of the presentation of the answers is altered including that of the correct answer to preclude the possibility of selecting the correct answer based on position in the answers presented in the pull-down menu. The number of answers including the correct answer presented in the pull-down menu can be configured by the system, and may vary in number from one to one hundred and twenty. Those familiar with the art will respect economy and security may be factor into the number of answers selected.

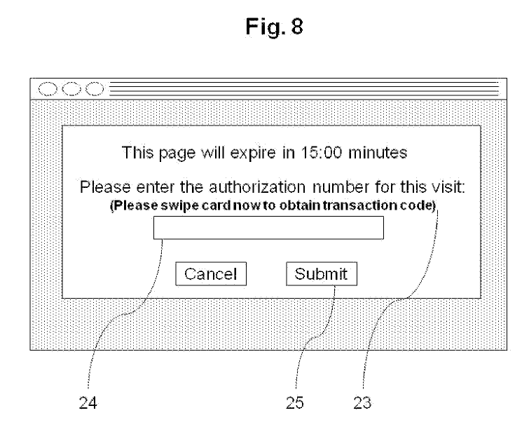

Upon the successful answering of the second security question presented in a web browser FIG. 8 shows, a question is prompted of the user to authorize the account and swipe the credit/debit card in the card reader 23 and type the authorization number into the text field in the web browser 24. The authorization number if produced with a credit card reader will be printed on a receipt with the time and date for viewing or on the credit card reader screen. In a preferred embodiment, the user or patient is in a healthcare environment with a credit card reader for payment with credit cards.

The patient presents their credit card to the healthcare provider or healthcare clerk (system user). The system user swipes the credit card in the machine and charges in advance for the service or enters a charge amount of zero (0) dollars for the amount in the text field 24 in FIG. 8. The credit card machine contacts the credit card server and the credit card server authorizes the account comparing the request to user data in the credit card database. If the card is not authorized the credit card server declines the card and sends a message to the credit card machine of “not approved” or “declined”. A record is made in the user's credit card account database of the attempted charge and decline.

If the charge is approved by the credit card payer, the credit card server sends, via secure internet connection, hard-line or otherwise a transmission to the healthcare information server containing the transaction authorization number, date and time. This authorization number is stored on the healthcare information server in respective fields in the users account in the database located on the healthcare server. The transaction number will also be printed on a receipt if a credit card machine is used.

When the user is presented with the screen requesting the authorization number be entered into the form field 24 in the web interface as shown in FIG. 8, the system compares this number entered by the user after the submit button is pressed to the number in the user data located on the healthcare server in the corresponding database field, which stores the authorization number. Respectively the user will read the authorization number from the receipt after printing from the credit card machine.

In the preferred embodiment the date and time fields in the database corresponding to the issuance of the authorization number, alternatively called “transaction code”, by the financial server are compared to the time the form data is sent when the user presses the “submit” button 25 on the webpage once the authorization number is entered in screen shown in FIG. 8. A time limit is employed by the system as defined in the preferred embodiment, in embodiment presented in this example it is 5 minutes. If the correct authorization number is not submitted in the webpage form by depressing the “submit” button 25 within the allocated time frame, the system requires the user to re-swipe the card and enter a new authorization code in a refreshed webpage. If the user is unable to enter a matching authorization code on the webpage, the system allows a total of 3 attempts then notifies the user via email of the unsuccessful attempts on the account.

When the validation code is entered into the webpage and a match is made within the time frame specified by the system, the user is directed to the medical information associated to the card number and user.

In the preferred embodiment the medical information, consisting of a personal health record, lab values, electronic medical record or the like is presented to the user via the web browser. Those familiar with the art will respect the medical information can be presented via a local program on the users computer, such as an executable, java program or the like.

What is claimed is:

1) A method for validating access to stored medical information utilizing transaction specific identification information, namely transaction validation code, supplied by electronic payers.

2) The method in (1) above whereby the identification information is used to temporally limit access the information

3) The method in (1) above whereby the transaction identification information is used in conjunction with questions and standard practice security measures.
